(19) United States
(12) Patent Application Publication
(10) Pub. No.: US 2019/0115694 A1
(43) Pub. Date: Apr. 18, 2019

(54) Electric Connector

(71) Applicant: Amphenol PCD Shenzhen Co.Ltd., Shenzhen (CN)

(72) Inventor: Shuangxiong QU, Xiangtan (CN)

(73) Assignee: Amphenol PCD Shenzhen Co.Ltd., Shenzhen (CN)

(21) Appl. No.: 15/951,239

(22) Filed: Apr. 12, 2018

(30) Foreign Application Priority Data
Oct. 17, 2017 (CN) 201721338712.X

(51) Int. Cl. H01R 13/639; H01R 24/20; H01R 13/627; H01R 13/422; H01R 33/76

(52) U.S. Cl. CPC H01R 13/639; H01R 24/20; H01R 2201/26; H01R 13/422; H01R 33/7671; H01R 13/6271

(57) ABSTRACT

An electric connector includes a plug and a socket. The plug includes a jack, a first lock and a second lock, the jack is defined inside the plug, and the first lock and the second lock are formed into the jack. The socket includes an insert part with a first hook and a second hook disposed thereon, and the insert part is configured to be inserted into the jack in an inserting direction. The first lock is located behind the second lock in the inserting direction. When the insert part is partly inserted into the jack the first hook engages with the first lock, and when the insert part is completely inserted into the jack the second hook engages with the second lock and the first hook is disengaged from the first lock, which makes the plug and the socket double lock preventing them separating from each other.

### CROSS REFERENCE TO RELATED APPLICATION

This non-provisional patent application claims priority under 35 U.S.C. § 119 from Chinese Patent Application No. 201721338712.X filed on Oct. 17, 2017, the entire content of which is incorporated herein by reference.

### TECHNICAL FIELD

The present invention relates to the field of connector, and in particular to electric connector.

### BACKGROUND

Currently, it is important for an electric vehicle to be equipped with a high voltage system which can provide enough power performance. A traditional connector usually comprises a plug and a socket into which the plug is inserted when needed. It is important to maintain the plug and the socket tightly connected, not loosened, and not separated from each other, therefore, various locking devices are adopted for locking the plug and socket.

However, as for most electric connectors on the market, the plug and the socket can be locked only once, it's structure is simple but unreliable. The plug and the socket are easy to loosen. Once the plug and the socket loosen, the high voltage from the electric connector would cause harm to human or electric vehicle.

### SUMMARY

Thus, there is a desire for an improved electric connector.

In one aspect, the present invention provides An electric connector, comprising a plug and a socket, the plug including a jack, a first lock and a second lock, the jack being defined inside the plug, the first lock and the second lock being formed into the jack; the socket including an insert part with a first hook and a second hook disposed thereon, the insert part being configured to be inserted into the jack in an inserting direction;

wherein the first lock is located behind the second lock in the inserting direction, when the insert part is partly inserted into the jack the first hook engages with the first lock, and when the insert part is completely inserted into the jack the second hook engages with the second lock and the first hook is disengaged from the first lock.

Preferably, when the plug is withdrawn from the socket the second hook disengages from the second lock before the first hook disengages from the first lock.

Preferably, the first lock is located behind the second lock in an inserting direction of the insert part inserting into the jack.

Preferably, the socket further comprises a first port opposite from the insert part and used to connect with an external device, the first hook comprises a first engaging surface used to lock with the first lock, the second hook comprises a second engaging surface used to lock with the second lock, and the first engaging surface is closer to the first port than the second engaging surfacing.

Preferably, the first hook further comprises a third bevel which is at an acute angle to the first bevel, and the third bevel is configured to push the first lock to deform it.

Preferably, the second hook further comprises a forth bevel which is at an acute angle to the second bevel, and the forth bevel is configured to push the second lock to deform it.

Preferably, the electric connector further comprises a moving part, the plug is configured with a slot for the moving part to insert, the moving part comprises a third lock configured to urge the second lock to interlock with the second hook.

Preferably, the moving part comprises an enlarged end acting as a first operating part for operating the moving part.

Preferably, the first operating part is configured with anti-skid pattern on an outer surface thereof.

Preferably, the moving part comprises a salient, and the plug comprises a limiting part which is used to block off the salient to avoid the moving part to escape from the plug.

Preferably, the plug further comprises a press section connected with the second lock so that the second lock can tilt outwardly when the press section is pressed inwardly.

Preferably, the press section is configured with anti-skid pattern.

Preferably, the number of the first lock is at least two, and the number of the first hook corresponds to the number of the first lock.

Preferably, the socket comprises a guiding rib disposed on the insert part, and the plug comprises a guiding slot defined in a wall of the jack for receiving the guiding rib.

Preferably, the socket comprises a flange extending outwardly from the insert part, and the flange is configured with a ring groove for receiving a sealing ring therein.

In the electric connector of the present invention, the first lock on plug and the first hook on the socket lock, and the second lock on plug and the second hook on the socket lock, which makes the plug and the socket double lock to avoid the two separate from each other.

### BRIEF DESCRIPTION OF THE DRAWINGS

FIG. 1 is the schematic of the electric connector while the plug and the socket contact but not connect; and

FIG. 2 is the longitudinal sectional view of FIG. 1; and

FIG. 3 is the schematic of the electric connector while the plug and the socket connect once; and

FIG. 4 is the longitudinal sectional view of FIG. 3; and

FIG. 5 is the schematic of the electric connector while the plug and the socket connect completely; and

FIG. 6 is the longitudinal sectional view of FIG. 5.

FIG. 7 is the schematic of the plug and the socket; and

FIG. 8 is the longitudinal sectional of the socket; and

FIG. 9 is the schematic of the plug.

FIG. 10 is the longitudinal sectional of the plug.

Reference numerals of main components:

10, socket; 11, flange; 12, insert part; 13, first hook; 131, second bevel; 132, first bevel; 14, second hook; 141, fourth bevel; 142, third bevel; 15, first port; 111, mounting hole 112, guiding rib; 20, plug; 22, jack; 23, first lock; 24 second lock; 25 third lock; 26, moving part; 261, first operating part; 262, salient; 263, anti-skip pattern 27, press section; 271, second operating part; 28, second port; 211, limiting part; 212, guiding slot; 30, sealing ring.

### DETAILED DESCRIPTION OF THE EMBODIMENTS

Referring to FIGS. 1 to 10, an electric connector in accordance with an embodiment of the present invention comprises a socket 10 and a plug 20 inserted into the socket 10.

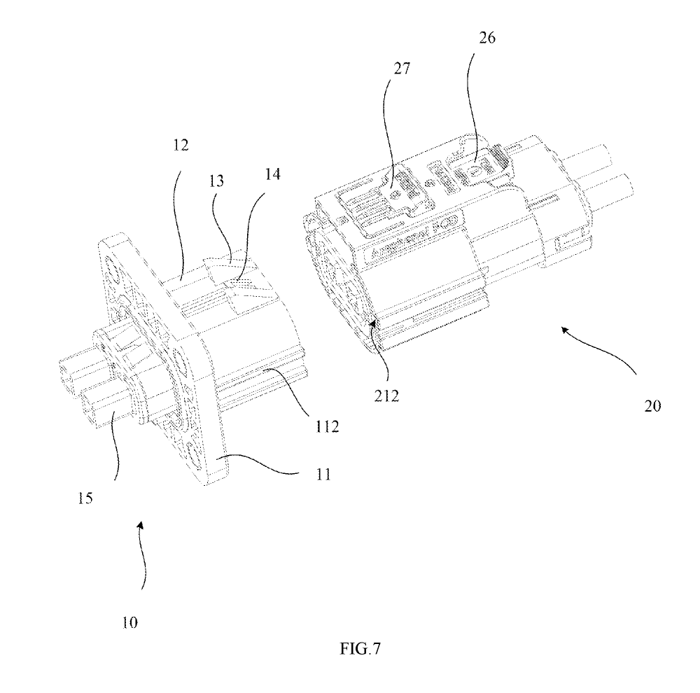

Referring to FIG. 1, FIG. 5 and FIG. 6, the plug 20 includes a jack 22, a first lock 23 and a second lock 24. The jack 22 is defined inside the plug 20, and the first lock 23 and the second lock 24 are formed into the jack 22.

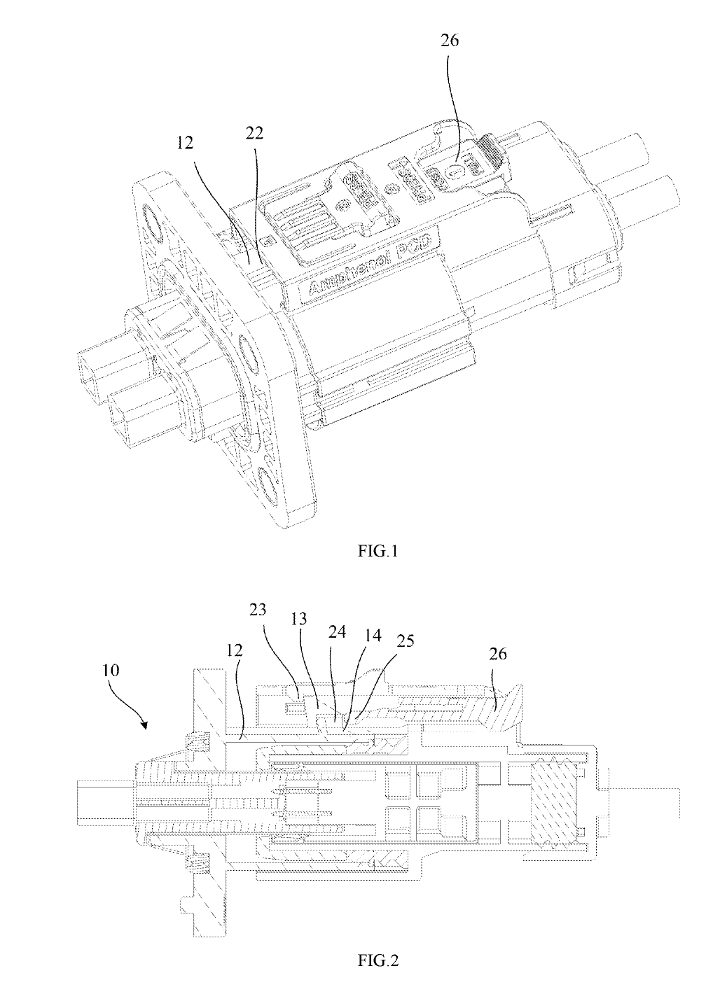

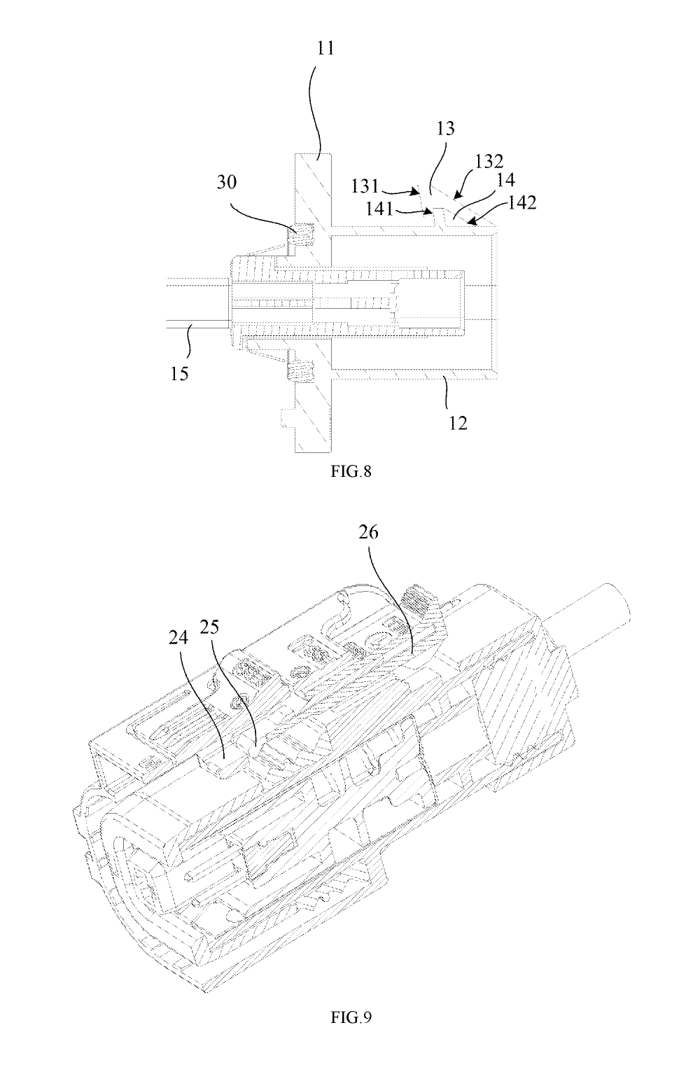

Referring to FIG. 2 and FIG. 7, the socket 10 includes an insert part 12 with a first hook 13 and a second hook 14 disposed thereon. The first hook 13, the second hook 14 and the insert part 12 are configured to be inserted into the jack 22. When the plug 20 is inserted into the socket 10, the first hook 13 engages with the first lock 23 before the second hook 14 engages with the second lock 24. The socket 10 and the plug 20 are electrically connected. The socket 10 further comprises a first port 15 configured to connect with external devices. The plug 20 comprises a second port 28 configured to connect with circuits.

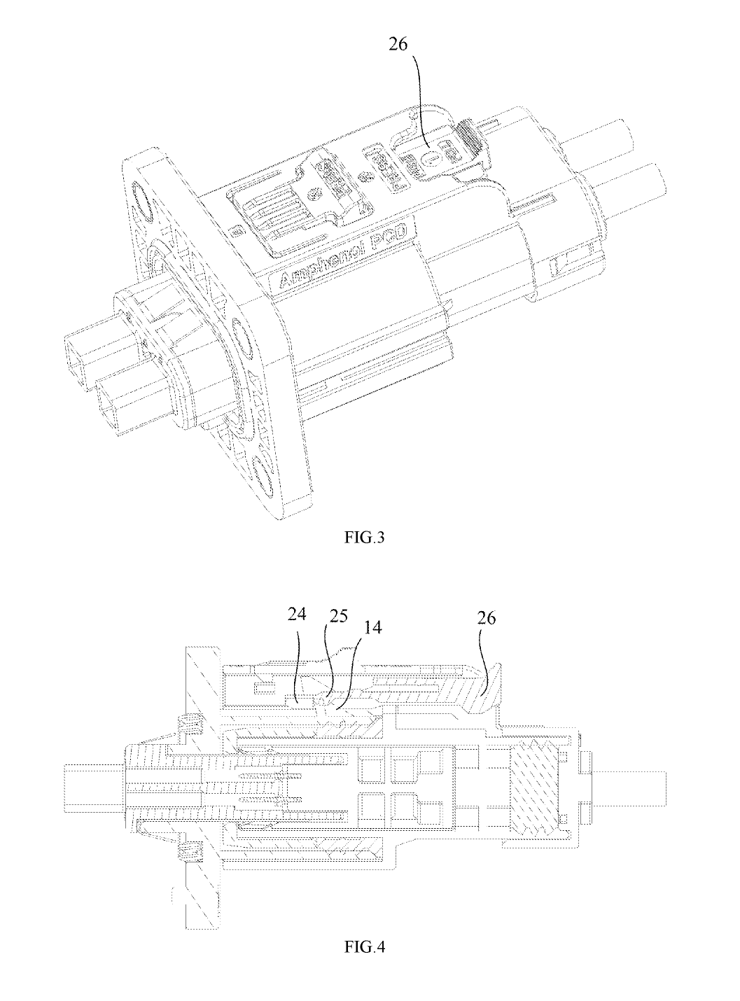

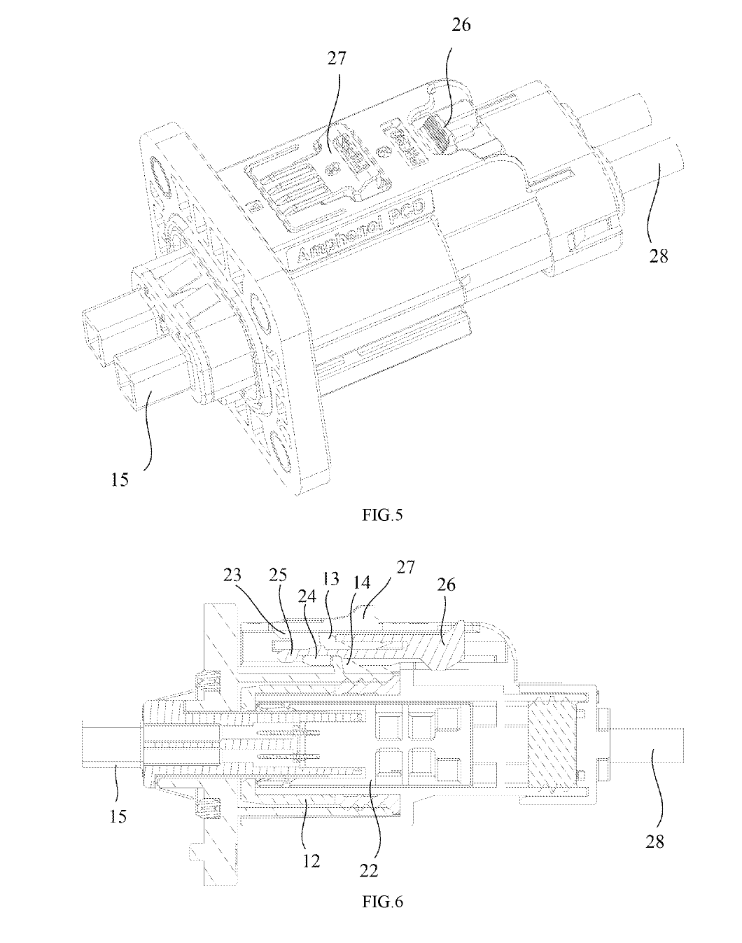

Referring to FIG. 1 and FIG. 2, the insert part 12 of the socket 10 is partially inserted into the jack 22 of the plug 20, and the first lock 23 and the first hook 13 lock with each other. Referring to FIG. 3 and FIG. 4, pulling the plug 20 toward the socket 10 or pulling the socket 10 toward the plug 20 to cause the insert part 12 of the socket 10 to be completely inserted into the jack 22 of the plug 20, the first lock 23 and the first hook 13 lock with each other, and the second lock 24 and the second hook 14 are separated with each other. Referring to FIG. 5 and FIG. 6, after the insert part 12 of the socket 10 is completely inserted into the jack 22 of the plug 20, the third lock 25 presses on the second lock 24 to prevent the second lock 24 from disengaging from the second hook 14. Thus, the plug 20 and the socket 10 are firmly connected with each other.

During assembly, connecting the first lock 23 to the first hook 13 first, then connecting the second lock 24 to the second hook 14. Therefore, the plug 20 and the socket 10 double lock, so that the connection between the two is more stable and not easy to loosen.

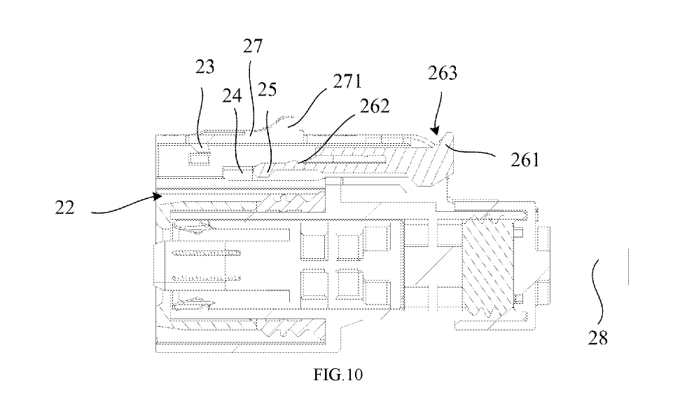

Referring to FIG. 8 and FIG. 10, the socket 10 further comprises a flange 11 extending outwardly from the end of the insert part 12. The first hook 13 is closer to the flange 11 than the second hook 14. The first hook 13 comprises a first engaging surface used to lock with the first lock 23, the second hook 14 comprises a second engaging surface used to lock with the second lock 24, the first engaging surface is configured a bevel, and it shows in FIG. 8 as second bevel 131, and the second engaging surface is configured a bevel, and it shows in FIG. 8 as fourth bevel 141, and the second bevel 131 is closer to the flange 11 as compared to the fourth bevel 141. The second lock 24 is closer to the opening of the jack 22 than the first lock 23. When the insert part 12 is inserted through the opening and into the jack 22, due to the first hook 13 is more prominent than the second hook 14, and the fourth bevel 141 is closer to the insert part 12 than the second bevel 131, the first hook 13 and the first lock 23 lock first with the second hook 14 cross the first lock 23.

The first hook 13 further comprises a first bevel 132 which is at an acute angle to the second bevel 131, and the first bevel 132 is configured to push the first lock 23 to deform it outwardly when the first hook 13 is passing through the first lock 23 during the process of the insert part 12 being inserted into the jack 22. The When the first hook 13 contacts the first lock 23, the first bevel 132 push the first lock 23 to deform it until the first hook 13 cross over the first lock 23, when the first hook 13 crosses over completely the first lock 23, the first lock 23 restores and interlocks with the first hook 13.

The second hook 14 comprises a third bevel 142 which is at an acute angle to the fourth bevel 141, and the third bevel 142 is configured to push the first lock 23 to deform it outwardly. When the second hook 14 contacts the second lock 24, the third bevel 142 push the second lock 24 to deform it until the second hook 14 cross over the second lock 24, when the second hook 14 cross over completely the second lock 24, the second lock 24 restore and lock the second hook 14.

Referring to FIG. 9 and FIG. 10, the electric connector further comprises a moving part 26. The plug 20 defines a slot for the moving part 26 to insert. The moving part 26 comprises the third lock 25 which contacts with the second lock 24 when the moving part 26 inserting inside the slot holly the second lock extends from the sidewall of the jack 22. When the moving part 26 is inserted into the slot and crosses over the second lock 24, the third lock 25 presses against the second lock 24 to cause the second lock 24 being interlocked with the second hook 14. When assembling the plug 20 and the socket 10, the moving part 26 is withdrawn from the slot to release the second lock 24, so that the third bevel 142 can push the second lock 24 to deform it, and when the second hook 14 crosses over the second lock 24, push the moving part 26 inwardly until the third lock 25 crosses over and presses the second lock 24 downwardly so that the second lock 24 is locked with the second hook 14 tightly, which means the plug 20 and the socket 10 lock once. In contrast, when the moving part 26 is pulled out of the slot, the third lock 25 and the second lock 24 are separated, the second hook 14 is released from the second lock 24.

Referring to FIG. 9, the moving part 26 comprises a first operating part 261 for operating the moving part 26. The operating part 261 protrudes outwardly which is convenient for operator to hold.

The operating part 261 is configured to have anti-skip pattern 263 on its outer surface so that the operator would not slide when hold the moving part 26.

The moving part 26 comprises a salient 262, and the plug 20 comprises a limiting part 211 which block off the salient 262 to avoid the moving part 26 to escape the plug 20. Pulling the moving part 26 from the cord slot until the third lock 25 and the second lock 24 releases, but avoid the moving part 26 escape the plug 20. The salient 262 and the limiting part 211 form a limit to the moving part 26.

The plug 20 further comprises a press section 27 configured to connect with the first lock 23 so that the first lock 23 can be moved through pressing the press section 27. When the press section 27 is pressed, the first lock 23 will tilt up to move away from the first hook 13. The press section 27 is exposed to the outside of the plug 20 so that the operator can press it. The press section 27 is configured with a second operating part 271 to make it easy to operate the press section 27.

The press section 27 is configured with anti-skid pattern so that the operator would not slide when press the press section 27.

Referring to FIG. 8, the number of the first lock 23 is at least two, and the number of the first hook 13 corresponds to the number of the first lock 23. The larger the number of the first lock 23 and the first hook 13 is, the more stable the connection between the plug 20 and the socket 10 is.

Referring to FIG. 7, the socket 10 comprises a guiding rib 112 disposed on the insert part 12, and the plug 20 comprises a guiding slot 212 disposed on wall of the jack 22 which fits to the guiding rib 112. The guiding rib 112 and the guiding slot 212 cooperate to guide the insertion of the insert part 12 into the jack 22 and to avoid the insert part 12 from rotating relative to the plug 20.

The flange 11 defines a ring groove for accommodating a sealing ring 30 therein. When the plug 20 is mounted to an external device, the sealing ring 30 is sandwiched between the flange 11 and the external device to stop dust or water from entering into the electric connector. The flange 11 has mounting holes 111 for passing through of fasteners to connect with the external device.

Therefore, the technical solutions of embodiments of the present invention have been clearly and completely described above. Apparently, the described embodiments are merely part of, rather than all of, the embodiments of the present invention. A person skilled in the art may make various combinations of technical features in the various embodiments to meet practical needs. Based on the described embodiments of the present invention, any other embodiment obtained by a person skilled in the art without paying creative efforts shall also fall within the scope of the present invention.

1. An electric connector, comprising:
a plug, wherein the plug includes a jack, a first lock and a second lock, the jack is defined inside the plug, the first lock and the second lock are formed into the jack;
a socket, wherein the socket includes an insert part with a first hook and a second hook disposed thereon, the insert part is configured to be inserted into the jack in an inserting direction;
wherein the first lock is located behind the second lock in the inserting direction, when the insert part is partly inserted into the jack the first hook engages with the first lock, and when the insert part is completely inserted into the jack the second hook engages with the second lock and the first hook is disengaged from the first lock.

2. The electric connector of claim 1, wherein when the plug is withdrawn from the socket, the second hook disengages from the second lock before the first hook disengages from the first lock.

3. The electric connector of claim 2, wherein the first lock is located behind the second lock in the inserting direction of the insert part inserting into the jack.

4. The electric connector of claim 1, wherein the socket further comprises a first port opposite from the insert part and is used to connect with an external device, the first hook comprises a first engaging surface to lock with the first lock, the second hook comprises a second engaging surface to lock with the second lock, and the first engaging surface is closer to the first port than the second engaging surface.

5. The electric connector of claim 2, wherein the first hook further comprises a first bevel provided at an acute angle to a second bevel, and the first bevel is configured to push the first lock to deform the first lock.

6. The electric connector of claim 5, wherein the second hook further comprises a third bevel provided at an acute angle to a fourth bevel, and the third bevel is configured to push the second lock to deform the second lock.

7. The electric connector of claim 1, wherein the electric connector further comprises a moving part, the plug is provided with a slot for inserting the moving part, and the moving part comprises a third lock configured to urge the second lock to interlock with the second hook.

8. The electric connector of claim 7, wherein the moving part comprises a curved end acting as a first operating part for operating the moving part.

9. The electric connector of claim 8, wherein the first operating part is provided with a first anti-skid pattern on an outer surface of the first operating part.

10. The electric connector of claim 7, wherein the moving part comprises a salient, and the plug comprises a limiting part, wherein the limiting part blocks off the salient to avoid the moving part to escape from the plug.

11. The electric connector of claim 1, wherein the plug further comprises a press section connected with the second lock so that the second lock can tilt outwardly when the press section is pressed inwardly.

12. The electric connector of claim 11, wherein the press section is provided with a second anti-skid pattern.

13. The electric connector of claim 1, wherein the socket further comprises a guiding rib disposed on the insert part, and the plug comprises a guiding slot defined in a wall of the jack for receiving the guiding rib.

14. The electric connector of claim 1, wherein the socket further comprises a flange extending outwardly from the insert part, and the flange is configured with a ring groove for receiving a sealing ring therein.

15. An electric connector, comprising:
a plug, wherein the plug includes a jack, a plurality of first locks and a second lock, the jack is defined inside the plug, the plurality of first locks and the second lock are formed into the jack;
a socket, wherein the socket includes an insert part with a plurality of first hooks and a second hook disposed thereon, the insert part is configured to be inserted into the jack in an inserting direction;
wherein the plurality of first locks are located behind the second lock in the inserting direction, when the insert part is partly inserted into the jack the plurality of first hooks engage with the plurality of first locks, and when the insert part is completely inserted into the jack the second hook engages with the second lock and the plurality of first hooks are disengaged from the plurality of first locks.
